(19) United States
(12) Patent Application Publication
(10) Pub. No.: US 2015/0249616 A1
(43) Pub. Date: Sep. 3, 2015

(54) APPARATUS AND METHOD FOR SUPPORTING MULTI-HOST ACCESS

(71) Applicant: SAMSUNG ELECTRONICS CO., LTD., Suwon-si Gyeonggi-do (KR)

(72) Inventors: Jong-Hyo Lee, Gyeonggi-do (KR); Jun-Hyung Kim, Gyeonggi-do (KR); Joo-Yeol Lee, Gyeonggi-do (KR); Ji-Hye Lee, Seoul (KR); Se-Hee Han, Seoul (KR)

(73) Assignee: Samsung Electronics Co., Ltd., Suwonsi-si, Gyeonggi-do (KR)

(21) Appl. No.: 14/436,005

(22) PCT Filed: Oct. 16, 2013
(86) PCT No.: PCT/KR2013/009256

§ 371 Date: Apr. 15, 2015

(30) Foreign Application Priority Data
Oct. 17, 2012 (KR) 10-2012-0115319

(51) Int. Cl. H04L 12/911; H04L 29/06

(52) U.S. Cl. CPC H04L 47/70; H04L 69/22

(57) ABSTRACT

The present invention relates to an apparatus and method for supporting multi-host access. According to the present invention, a hub can detect which host transmits a message without a future change of USB layers by allocating a host port ID and providing an individual identifier to each host in a hub PAL.

### TECHNICAL FIELD

The present disclosure relates to an apparatus and method for supporting multi-host access.

### BACKGROUND ART

Wi-Fi Serial Bus (WSB) refers to a technology to make a wirelessly connection using a Wireless Fidelity (Wi-Fi) link between a Universal Serial Bus (USB) host and a USB hub/USB device.

Conventionally, a communication module in which a USB hub/device can communicate with a host in a USB layer has been mounted in duplication to support multiple hosts. However, the requirement for physically mounting the module to support multiple hosts is not efficient and causes problems such as price increases. Thus, in supporting a wireless USB, a scheme which can support the multiple hosts without a change of the USB-layer has been demanded.

### DETAILED DESCRIPTION OF THE DISCLOSURE

### Technical Problem

The present disclosure provides an apparatus and method which can support multi-host access.

The present disclosure provides an apparatus and method which can support multiple hosts without a change of a USB-layer.

### Technical Solution

A method of supporting multi-host access by a hub in a communication system for supporting a wireless Universal Serial Bus (USB) according to an embodiment of the disclosure includes: receiving a connection request based on a Protocol Adaptation Layer (PAL) from a host; allocating a host port identifier; and transmitting the allocated port to each host.

An apparatus for supporting multi-host access by a hub in a communication system for supporting a wireless Universal Serial Bus (USB) according to an embodiment of the present disclosure includes: a reception unit that receives a connection request based on a Protocol Adaptation Layer (PAL); a controller that allocates a host port identifier; and a transmission unit that transmits the allocated port to each host.

### Advantageous Effects

The present disclosure can effectively support multi-host access.

The present disclosure can support multiple-hosts without a change of a USB-layer.

According to the present disclosure, a hub can detect which host transmits a message without a future change of USB layers by allocating a host port ID and providing an individual identifier to each host in a hub PAL.

### BRIEF DESCRIPTION OF THE DRAWINGS

FIG. 1 is a configuration diagram illustrating a communication system to support multi-host access;

FIG. 2 is a flowchart illustrating an operation between a WSB host and a WSB hub to support multi-host access according to an embodiment of the present disclosure;

FIG. 3 is a flowchart illustrating an operation between a WSB host and a WSB hub to support multi-host access according to an embodiment of the present disclosure;

FIG. 4 is a configuration diagram illustrating a header of a packet according to an embodiment of the present disclosure;

FIG. 5 is a block diagram illustrating a hub PAL according to an embodiment of the present disclosure;

FIG. 6 is a flowchart illustrating an operation of a hub PAL according to an embodiment of the present disclosure;

FIG. 7 is a block diagram illustrating a host according to an embodiment of the present disclosure; and

FIG. 8 is a flowchart illustrating an operation of a host according to an embodiment of the present disclosure.

### MODE FOR CARRYING OUT THE DISCLOSURE

Hereinafter, exemplary embodiments of the present disclosure will be described in detail with reference to the accompanying drawings. Although particular matters are shown in the following description, it will be apparent to those skilled in the art to which the present disclosure pertains that the particular matters are provided only to help a comprehensive understanding of the present disclosure, and various modifications and changes can be made within the scope of the present disclosure.

The present disclosure proposes a WSB hub for supporting multiple upstreams to support multi-host access.

In the present disclosure, a message exchanged between a WSB host and a WSB hub is based on a WiGig Serialbus Extension standard defined by Wireless Gigabit Alliance. WiGig is applicable in a wireless communication technology which operates at 60 Ghz or a wireless communication technology, such as Wi-Fi. The present disclosure defines an extension of the message defined in the standard.

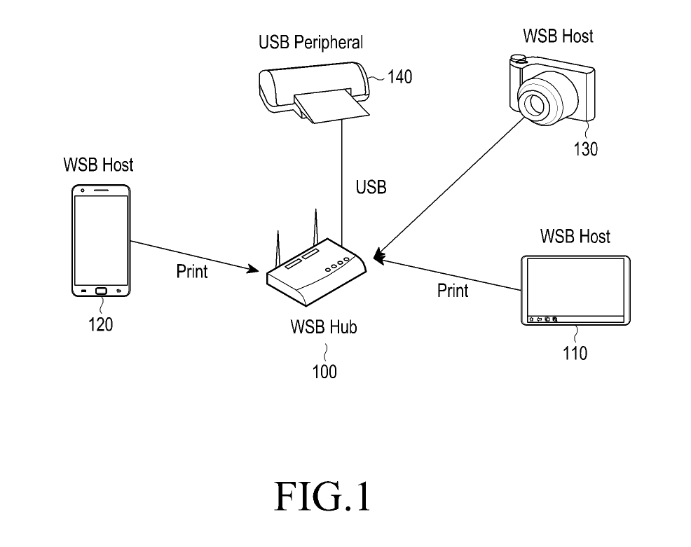

FIG. 1 shows a configuration diagram of a communication system for supporting multi-host access.

Referring to FIG. 1, the communication system for supporting multi-host access includes a WSB Hub 100, WSB Hosts 110, 120, and 130, a USB device 140, and the like.

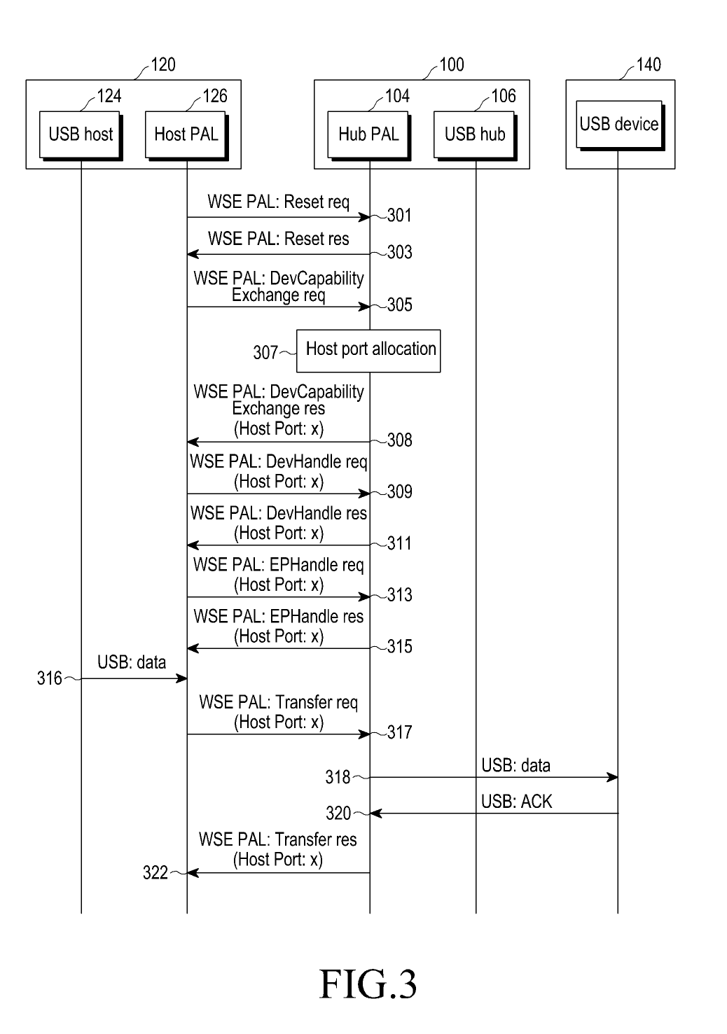

The WSB Hub 100 allocates a unique ID to each WSB Host when being connected with the WSB Host to support multiple upstreams. In addition, the WSB Hub 100 identifies each USB session in a set with an End Point (EP) by inserting a unique port ID of the host into the header of all WSB messages (e.g., all messages in FIG. 3 to be mentioned later may be included). At this time, the port ID refers to a port identifier for identifying the host.

The WSB Hub 100 allocates a new port ID DeviceCapabilityExchange during the first connection (association) with a WSB Host 120 and transmits the new port ID to the WSB Host (between 0 and 255, 8 bits).

Thereafter, all WSB Host 120 communicating with the WSB Hub 100 always add a unique identifier to all outgoing messages. Then, the WSB Hub 100 can detect which WSB Host transmits a message by viewing the unique identifier (that is, a host port) of the WSB Host of all received messages.

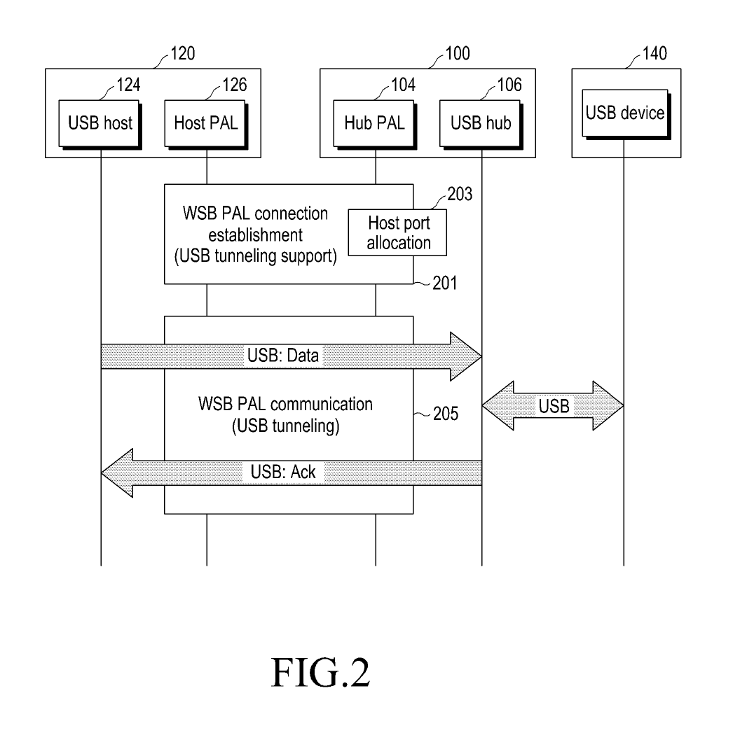

FIG. 2 is a flowchart illustrating an operation between a WSB host and a WSB hub to support multi-host access according to an embodiment of the present disclosure.

The communication system supporting the multi-host access of FIG. 2 is configured by a WSB host 126, a WSB hub 106, and a USB device 140.

The WSB host 126 is configured by the USB host layer 124 (hereinafter referred to as, “USB host”) and a Host Protocol Adaption Layer (PAL) 120 (hereinafter referred to as, “Host PAL”), which are described in FIG. 2, and a physical layer which is not shown in FIG. 2.

The WSB Hub 100 is configured by a USB hub layer 106 (hereinafter referred to as, “USB hub”) and a Host Protocol Adaption Layer (PAL) 120 (hereinafter referred to as, “Host PAL”), which are described in FIG. 2 , and a physical layer which is not shown in FIG. 2.

Although the USB device 140 is not described in FIG. 2, the USB device 140 is configured by a USB device layer, a Device PAL (Protocol Adaption Layer) layer, and a physical layer.

In the present disclosure, there is no change at all in a USB layer, that is, the USB host 124 and the USB hub 106.

The Host PAL 120 of the WSB host 126 and the Hub PAL 104 of the WSB Hub 100 establish a connection (indicated by reference numeral 201) with WSB PAL. At this time, USB tunneling between the Host PAL 120 and the Hub PAL 104 is supported.

The Hub PAL 104 provides an individual identifier (e.g., a host port ID) to each WSB host 120, 130 and 140 connected to the WSB Hub 100 by allocating the host port to the existing process when the connection of the WSB PAL is established (indicated by reference numeral 203).

WSB PAL communication is performed (indicated by reference numeral 205) between the Host PAL 120 and the Hub PAL 104 using the USB tunneling.

All the WSB hosts communicating with the WSB hub in the future always add the unique identifiers to the all outgoing messages. Then, the receiving WSB hub can figure out which host transmits the message by viewing a host unique identifier (a host port) included in all messages.

The USB function of the host is performed in the same manner as communication through a general WSB hub when communicating with the USB device through the WSB hub. When the Host sends a USB message to the USB device, the Host PAL within the host transmits the message to the WSB host by adding a host identifier upon tunneling the USB message.

Without any change in a USB procedure, the multi-host can be connected with the USB device through a USB message routing by the Hub PAL.

A DHCP function of an AP or a wireless sharer is an address scheme for supporting end-to-end addressing, a port of the TCP/UDP is used to identify an upper protocol session. On the contrary, the role of the host identifiers of the present disclosure is used to support a physical mapping.

FIG. 3 is a flowchart illustrating an operation between a WSB host and a WSB hub to support multi-host access according to an embodiment of the present disclosure.

First, the Host PAL 120, in step 301, transmits a Reset request message to the Hub PAL 104.

The Hub PAL 104, in step 303, in response to the Rest request message, transmits a Reset response message to the Host PAL 120.

The Host PAL 120, in step 305, transmits to the Hub PAL 104 a DeviceCapabilityExchange request message for a connection request.

Then, the Hub PAL 104, in step 307, allocates a host port. The Host port refers to a unique identifier of the host.

The Hub PAL 104, in step 308, in response to the DeviceCapabilityExchange request message, transmits a DeviceCapabilityExchange response message including the host port number allocated in step 307 to the Host PAL 120.

The Host PAL 120, in step 309, transmits a DeviceHandle request message including the host port number allocated in step 307 to the Hub PAL 104.

The Hub PAL 104, in step 311, in response to the DeviceHandle request message, transmits a DeviceHandle response message including the host port number allocated in step 307 to the Host PAL 120.

The Host PAL 120, in step 313, transmits an EPHandle request message including the host port number allocated in step 307 to the Hub PAL 104.

The Hub PAL 104, in step 315, in response to the EPHandle request message, transmits an EPHandle response message including the host port number allocated in step 307 to the Host PAL 120.

When data has been received from the USB host 124 in step 316, the host PAL 120, in step 317, transmits a Transfer request message including the host port number allocated in step 307 to the Hub PAL 104.

The Hub PAL 104, in step 318, transmits data to the USB device 140 and in step 320, receives an acknowledge message from the USB device 140.

The Hub PAL 104, in step 322, in response to the Transfer request message, transmits a Transfer response message including the host port number allocated in step 307 to the Host PAL 126.

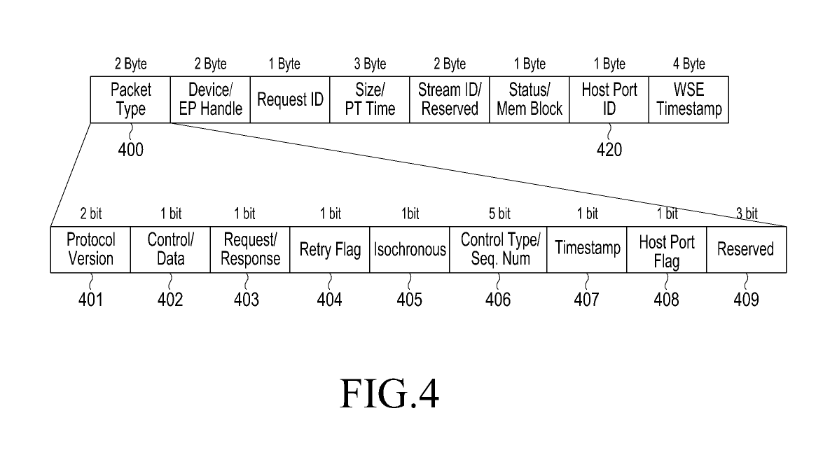

FIG. 4 is a configuration diagram illustrating a header of a packet according to an embodiment of the present disclosure.

A WSEPAL based packet includes a packet type field 400, device/EP handle field, a request ID field, a Size/PT time field, a Stream ID/Reserved field, a Status/Mem Block field, a Host Port ID field 420, a WSE Timestamp field, and the like.

The Host Port ID 420 allocates a host port value using an existing reserved field of 1 byte.

On the other hand, the packet type 400 includes a Protocol version 401, Control/Data 402, a Request/Response 403, a Retry Flag 404, an Isochronous 405, a Control Type/Sequence Number 406, a Timestamp 407, a host port flag 408, a Reserved field 409, and the like.

Whether to use a host or not is indicated by configuring the Host Port Flag 408 to some (one bit) of the existing Reserved field. In other words, 1-bit of the reserved field in a packet type among headers of the WSEPAL packet is defined as a multi-host addressing flag 408, and the reserved field (8 bits) of the packet header is used as the address (total 256 number of bits are possible).

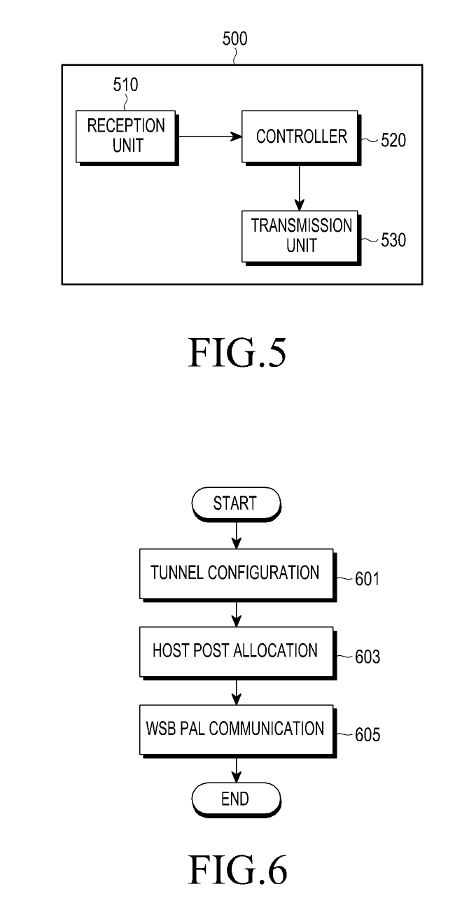

FIG. 5 is a block diagram illustrating a hub PAL according to an embodiment of the present disclosure.

A Hub PAL 104 includes a reception unit 510, a controller 520, and a transmission unit 530.

The reception unit 510 receives a connection request based on Protocol Adaptation Layer (PAL) from the Host PAL 126.

The controller 520 allocates a host port identifier when connection is established based on the Protocol Adaptation Layer (PAL) according to an embodiment of the disclosure.

The transmission unit 530 transmits a port identifier allocated by the controller 520 to each host.

FIG. 6 is a flowchart illustrating an operation of a Hub PAL according to an embodiment of the present disclosure.

First, the Hub PAL 104, in step 601, configures a tunnel for a connection establishment with the Host PAL 126.

During a connection establishment process, the Hub PAL 104, in step 603, allocates a host port identifier according to embodiment of the present disclosure.

The Hub PAL 104, in step 605, performs WSB PAL communication with the Host PAL 126.

The WSB PAL communication refers to operations of step 308 through step 322 of FIG. 3.

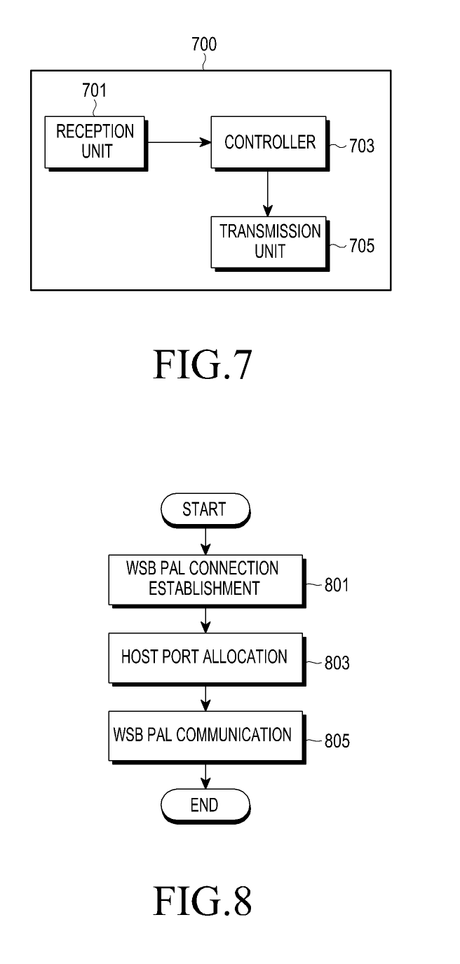

FIG. 7 is a block diagram illustrating a host according to an embodiment of the present disclosure.

A Host 120 is configured by a reception unit 701, a controller 703, and a transmission unit 705.

The controller 703 controls all operations of a host according to an embodiment of the disclosure, and establishes a connection based on a Protocol Adaptation Layer (PAL) with the hub 100.

The transmission unit 705 transmits a connection request based on the Protocol Adaptation Layer (PAL) from the host PAL 126.

The reception unit 701 receives a host port identifier allocated in the Hub PAL 104 according to an embodiment of the disclosure.

FIG. 8 is a flowchart illustrating an operation of a host according to an embodiment of the present disclosure.

First, the host 120, in step 801, configures a tunnel for a connection establishment with the hub 100.

During a connection establishment process, the Hub PAL 104, in step 803, allocates the host port identifier according to embodiment of the present disclosure.

The Host 120, in step 805, performs WSB PAL communication with the hub 100. The WSB PAL communication refers to operations of step 308 through step 322 of FIG. 3.

Although the present disclosure has been described above in conjunction with limitative embodiments and the drawings, the present disclosure is not limited to the aforementioned embodiments, and various modifications and alterations may be made therein by those skilled in the art to which the present disclosure pertains.

1. A method of supporting multi-host access by a hub in a communication system for supporting a wireless Universal Serial Bus (USB), the method comprising:
receiving a connection request based on a Protocol Adaptation Layer (PAL) from a host;
allocating a host port identifier; and
transmitting the allocated port to each host.

2. The method of claim 1, wherein the host port identifier is included in a header of a message which is transmitted between the hub and the host.

3. The method of claim 2, wherein 1 bit of a reserved field in a packet type of the header of the message is used to indicate whether to use a host port, and a reserved field of the header is used as a host port address flag.

4. An apparatus for supporting multi-host access by a hub in a communication system for supporting a wireless Universal Serial Bus (USB), the apparatus comprising:
a reception unit that receives a connection request based on a Protocol Adaptation Layer (PAL) from a host;
a controller that allocates a host port identifier; and
a transmission unit that transmits the allocated port to each host.

5. The apparatus of claim 4, wherein the host port identifier is included in a 2 5 header of a message which is transmitted between the hub and the host.

6. The apparatus of claim 5, wherein 1 bit of a reserved field in a packet type of the header of the message is used to indicate whether to use a host port, and the reserved field of the header is used as a host port address flag.

7. A method of supporting multi-host access by a host in a communication system for supporting a wireless Universal Serial Bus (USB), the method comprising the steps of:
transmitting a connection request based on a Protocol Adaptation Layer(PAL) to a hub; and
receiving a host port identifier which is allocated by the hub.

8. The method of claim 7, wherein the host port identifier is included in a header of a message which is transmitted between the hub and the host.

9. The method of claim 8, wherein 1 bit of a reserved field in a packet type of the header of the message is used to indicate whether to use a host port, and the reserved field of the header is used as a host port address flag.

10. An apparatus for supporting multi-host access by a host in a communication system for supporting a wireless Universal Serial Bus (USB), the apparatus comprising:
a transmission unit that transmits a connection request based on a Protocol Adaptation Layer(PAL) to a hub; and
a reception unit that receives a host port identifier which is allocated by the hub.

11. The apparatus of claim 10, wherein the host port identifier is included in the header of the message which is transmitted between the hub and the host.

12. The apparatus of claim 11, wherein 1 bit of a reserved field in a packet type of the header of the message is used to indicate whether to use a host port, and the reserved field of the header is used as a host port address flag.
